(19) United States
(12) Patent Application Publication
(10) Pub. No.: US 2008/0071732 A1
(43) Pub. Date: Mar. 20, 2008

(54) Master/slave index in computer systems

(76) Inventor: Konstantin Koll, Dortmund (DE)

Correspondence Address: Konstantin Koll, Hansmannstr. 17, Dortmund, 44227, omitted

(21) Appl. No.: 11/892,071

(22) Filed: Aug. 20, 2007

Related U.S. Application Data
(60) Provisional application No. 60/845,222, filed on Sep. 18, 2006.

(51) Int. Cl. G06F 17/30

(52) U.S. Cl. 707/2; 707/E17.002

(57) ABSTRACT

The master/slave index is an indexing method and apparatus that does not suffer from poor performance when stored in a file system by completely avoiding any seek operation when searching or updating the indexed information. Heterogenous attributes from objects of different types are split in a master index and at least one slave index, reserving no memory for non-existent attributes. Index tables can be merge-joined because they maintain their ordering across tables.

### CROSS-REFERENCE TO RELATED APPLICATIONS

This application is claiming the benefit under 35 § USC 119(e) of the prior provisional application 60/845,222 (master/slave index in computer systems), filed on Sep. 18, 2006.

### US PATENT REFERENCES

Merge join process, U.S. Pat. No. 6,185,557 issued Feb. 6, 2001.

### FIELD OF THE INVENTION

This invention is generally related to computer systems. More particularly, the invention is related to storage systems, including but not limited to file systems.

### BACKGROUND OF THE INVENTION

This invention has been made in the context of, but is not limited to, file systems. A file system associates files with a number of attributes, including but not limited to a name, the size of the file and time of last modification. Supplementing the attributes given to each file, certain file formats introduce further attributes specific to their file type.

To gain quick access to all attributes, they need to be indexed. The method and apparatus described herein enables quick access by taking the behaviour of file systems and storage media into account. Previously used indexes are derived from database systems and perform poorly when stored as files in file systems.

The poor performance of known indexing structures, including but not limited to trees in all embodiments, is caused by the fact that seek operations, i.e. jumps inside the file body, are needed when processing queries or updating the index. This is not the case when such indexes are stored in reserved and unstructured regions of the disc, which is the case with most database systems.

The indexing method and apparatus presented circumvents the penalties described above when storing the index in a file system by completely avoiding any seek operation in the index file, hence always reading them sequentially. Additionally, heterogenous attribute sets of different lengths are stored without wasting memory.

The advantages of the master/slave index also apply to other data with heterogenous attributes, hence of different type, including but not limited to tuples in relational databases that adhere to different schemes.

### SUMMARY OF THE INVENTION

According to an embodiment of the invention, an indexing system that stores attributes assigned to objects and comprises of at least one master index table and at least one slave index table. The master index table stores attributes that are properties of all objects to be indexed; a slave index stores attributes that are only properties of certain object types. The stored information is being altered or searched by merge-joining tuples across index tables that belong to the same object.

According to another embodiment of the invention, a master/slave index that stores attributes derived from files, including but not limited to so-called “metadata” extracted from the file body.

According to yet another embodiment of the invention, a master/slave index that stores attributes derived from tuples stored by databases, including but not limited to relational databases.

### DESCRIPTION OF THE DRAWINGS

FIG. 1 illustrates the master/slave index.

FIG. 2 illustrates the processing of a query on the master/slave index.

FIG. 3 illustrates the deletion of objects from the master/slave index.

### DETAILED DESCRIPTION OF THE INVENTION

The embodiments of the master/slave index are described using file system and relational database terminology familiar to one skilled in the art.

Files stored in a file system have got multiple attributes attached to them. The file system assigns standard attributes, including but not limited to filename, size and the date of the last write access. In addition to these attributes, file formats offer further attributes specific for a file type, e.g. the resolution of an image or the artist and song title of an MP3 audio file.

To be of any practical use, all files within a directory have to be read and parsed to access the metadata. Since this process is time consuming, it is common practice for applications to extract the attributes only once and store them in a more convenient structure which is called index, the method and apparatus presented here one embodiment thereof.

### Conceptional Overview

The basic idea of this utility is to store all attributes common to all data objects in a table which is called master index. For each type of data object that introduces additional attributes, an additional secondary table which is called slave index is stored.

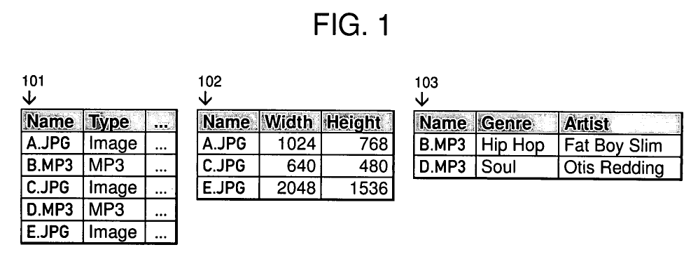

A specific embodiment of this idea is illustrated in FIG. 1. The master/slave index in FIG. 1 stores the attributes of five data objects. The master index 101 contains all attributes which occur in all five data objects, including but not limited to a name and the object type.

For each of the two object types in FIG. 1, JPEG images and MP3 audio files, secondary slave indexes 102 103 are introduced. They contain all attributes which occur only in the specific object type accounted for by the slave index table, supplemented by the name of each data object.

Since both the master index 101 and all slave indexes 102 103 store only attributes defined by specific data formats, no memory is wasted which is an advantage of this invention over the obvious approach to store all attributes from all data objects in a large single table.

### Adding Additional Data Objects

Additional data objects are indexed by appending their attribute tuples to the master index 101 and the appropriate slave index tables, i.e. 102 103 in FIG. 1, processing one data object at a time.

This method ensures that all data objects maintain their order in all index tables, which is a vital property for other operations presented in subsequent paragraphs. The order of two data objects is only relevant for objects of the same type: if a certain data object precedes another data object of the same type in the master index 101, it must do so in the appropriate slave index and vice versa.

If a given embodiment of the master/slave index fullfills this requirement, it will also do this after appending an additional element to the index tables, because the order of already existing tuples is not affected, and the appended attributes will both be the last tuples in master index 101 and the assigned slave index 102 103, thus also ordered.

### Query Processing

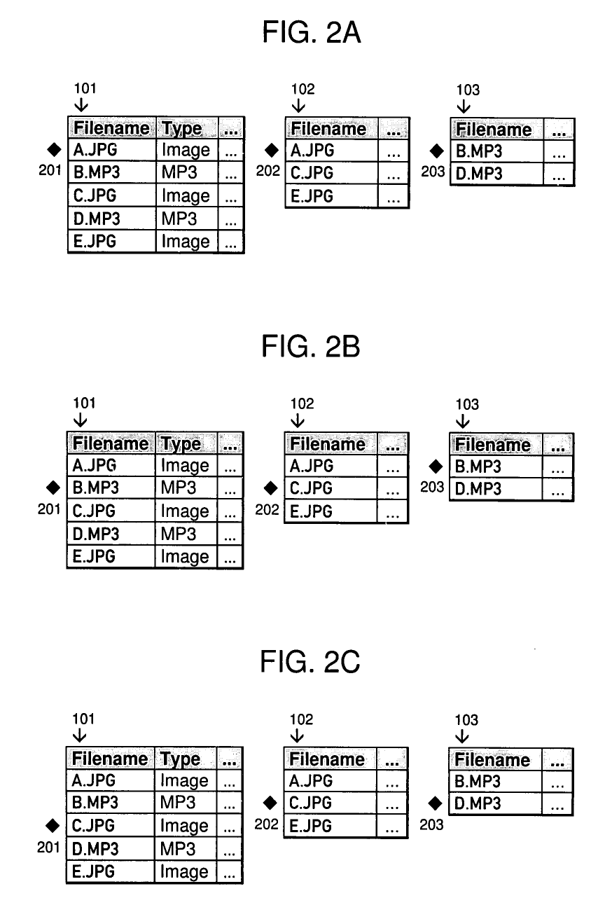

Processing queries over a given embodiment of a master/slave index is easily the most prominent function of this invention. A method for query processing, including but not limited to searching, is illustrated in FIG. 2.

In the beginning, a marker 201 202 203 is associated with each index table 101 102 103, pointing to the first tuple respectively. This is illustrated in FIG. 2A. It is assumed that the master/slave index is non-empty.

When the master/slave index has been created by appending tuples to the empty index as described in the paragraphs 22 to 24, the marker 201 in the master index 101 and the marker at the assigned slave index (202 in FIG. 2A) point to the attributes of the same data object, because elements maintain their order across tables as described in paragraph 24.

All attributes of the first data object are now available at the marker positions for processing in a search query (i.e. comparing with query properties) or for updating the attributes.

In a subsequent step, the marker 201 in the master index 101 and the marker 202 at the assigned slave index 102 are advanced to the next tuple in their respective index table or, if there is no further entry, disposed of.

The marker 201 in the master index 101 and the marker at the assigned slave index (203 in FIG. 2B) now point the attributes of the next data object.

The method described in the paragraphs above are repeated until all markers have been disposed of, hence the index tables have been processed completely. FIG. 2C illustrates the next iteration of this process.

This method of query processing requires no seek operating, i.e. jumps to other tuples other than subsequent ones, thus avoiding any overhead imposed by a file system.

As trees or similar indexing methods are generally considered to be efficient even by people skilled in the art, the method and apparatus presented here is not obvious to those.

### Removing Data Objects

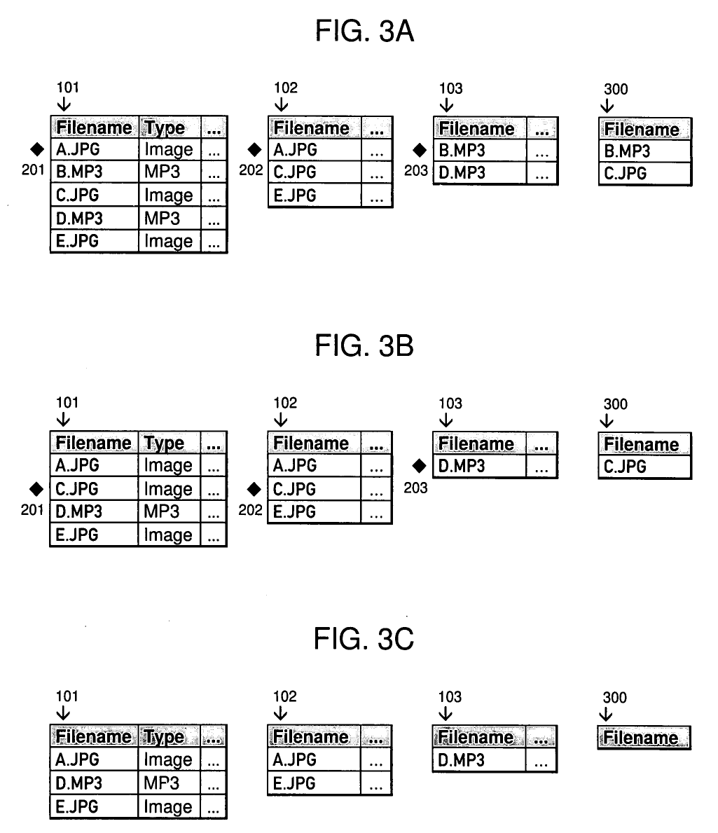

The deletion of attribute tuples from the master/slave index is illustrated in FIG. 3. In addition to the master index 101 and the slave indexes 102 103, an additional table called “deletion list” 300 is introduced, which contains references to the data objects to be deleted (file names in FIG. 3A).

The deletion process is very similar to the method of query processing described above, including the placement of markers 201 202 203 at the first tuple of each table. The deletion list 300 does not need any marker. This configuration is illustrated in FIG. 3A.

During processing as described above, each data object is looked up in the deletion list 300. If found, the tuple in the master index 101, the assigned slave index 102 and the deletion list 300 is removed. This is illustrated in FIG. 3B.

This method is repeated until either all data objects in the master/slave index have been processed, or the deletion 300 list becomes empty. This end situation is illustrated in FIG. 3C.

It is to be understood that the above description is intended to be illustrative, and not restrictive. Many other embodiments will be apparent to those skilled in the art upon reviewing the above description. The scope of the invention should, therefore, be determined with reference to the appended claims, along with the full scope of equivalents to which such claims are entitled.

What is claimed is:

1. An index system comprising: at least one master index table storing at least one attribute assigned to all objects; at least one slave index table storing at least one attribute not assigned to all objects, hence type-specific; a system to execute queries and update operations by joining table entries with a merge join or similar method

2. The index system of claim 1, wherein the attributes to be indexed are derived from a file body (so-called “metadata”)

3. The index system of claim 2, comprising at least one extractor to gather metadata

4. The index system of claim 3, wherein the system is able to add or remove an extractor from the system

5. The index system of claim 3, wherein at least one extractor is built into an application

6. The index system of claim 1, wherein the attributes to be indexed are derived from tuples that are stored in databases

7. The index system of claim 6, wherein the tuples are stored in a relational database

8. The index system of claim 1, wherein the system is able to add or remove slave index tables

9. The index system of claim 1, wherein data objects are added by appending tuples to the end of the master index and at least one slave index

10. The index system of claim 1, wherein the index is searchable to identify data objects with certain properties, comprising the steps of: assigning a marker to each of the index tables, including but not limited to the master index and all slave indexes; determining the type of the data object from its attributes stored in the master index; reading the marked tuple from the appropriate slave index, if any is assigned to the specific type; advancing the markers in the master index and the assigned slave index to their next tuple; repeating this until all data objects have been processed

11. The index system of claim 1, wherein data objects can be removed, comprising the steps of: assigning a marker to each of the index tables, including but not limited to the master index and all slave indexes; determining the type of the data object from its attributes stored in the master index; if the data object is referenced in the deletion list, removal of the marked tuples from the deletion list, the master index and the appropriate slave index, if any is assigned to the specific type; if the data object has not been referenced in the deletion list, advancing the markers in the master index and the assigned slave index to their next tuple; repeating this until all data objects have been processed or the deletion list becomes empty
